(19) United States
(12) Patent Application Publication
(10) Pub. No.: US 2026/0116050 A1
(43) Pub. Date: Apr. 30, 2026

(54) DAMPED SHEET METAL COMPONENTS, METHODS OF FORMING AND VEHICLES INCLUDING THE SAME

(71) Applicant: Intellectual Property Holdings, LLC, Cleveland, OH (US)

(72) Inventors: Edward Miyoshi, Strongsville, OH (US); Bill Roach, North Royalton, OH (US); Tim Whalen, Brighton, OH (US); Alex Papadopulos, Uniontown, OH (US); Ryan G. Sarkisian, Lakewood, OH (US); Dan T. Moore, Cleveland Heights, OH (US)

(21) Appl. No.: 18/468,334

(22) PCT Filed: Sep. 14, 2022
(86) PCT No.: PCT/US2022/043502

§ 371 Date: Sep. 15, 2023

Related U.S. Application Data
(60) Provisional application No. 63/243,805, filed on Sep. 14, 2021.

(51) Int. Cl. B32B 15/08; B32B 3/26; B32B 37/04; B32B 37/06; B32B 38/00; B32B 38/06

(52) U.S. Cl. CPC B32B 15/08; B32B 3/266; B32B 37/04; B32B 37/06; B32B 38/0012; B32B 38/06; B32B 2250/03; B32B 2307/56; B32B 2307/7376; B32B 2605/00

(57) ABSTRACT

An exemplary damped sheet metal motor vehicle component formed from a single stamping operation includes a base layer, a viscoelastic polymer layer, and a constraining layer. The base layer is a sheet metal motor vehicle component. The viscoelastic polymer layer is in an expanded condition. The constraining layer is welded to the base layer through the viscoelastic polymer layer prior to the single stamping operation.

### CROSS-REFERENCE TO RELATED APPLICATIONS

The present application is a U.S. national stage application under 35 U.S.C. § 371 of PCT Application No. PCT/US2022/043502, filed on Sep. 14, 2022, which claims priority to U.S. Provisional Application Ser. No. 63/243,805, filed on Sep. 14, 2021, the entire disclosures of which are incorporated herein by reference in their entirety.

### TECHNICAL FIELD

The present application relates generally to composite vibration damping systems, and more specifically to composite vibration damping systems including an expanding polymer layer and methods of forming the same.

### BACKGROUND

Vibrations experienced by vehicles such as cars and trucks can arise from outside the vehicle—i.e., from interactions of the vehicle with the road and air—and from inside the vehicle—i.e., from the engine and other moving parts of the car. Sheet metal is used to form many parts of a car and can transmit and amplify these vibrations to cause undesirable noise.

Various approaches to dampen vehicles vibrations have been tried. One approach is to add damping structures and materials to the sheet metal components to absorb the mechanical energy of vibration as it travels through the frame and body of the vehicle. Sheet metal structural components designed to dampen vibration can include structures such as multiple layers joined together to form laminated materials and can include non-metallic layers, for example rubber or plastic, that join the metal layers together to form damping structures. For example, a sheet metal component can include a metal constraining or damping layer joined to a metal base layer via a butyl rubber material that is sticky and adheres to both metal layers. The butyl rubber material acts as a energy absorber that restrains the stretching and compressing of the material caused by the vibration, thereby reducing the transmission of the vibrations through the sheet metal component. The constraining layer adhered to the base layer by butyl rubber can be in the form of a patch that is made from a flat sheet of metal having an included butyl layer that is faced with a release liner. The patch is cut to a desired shape and then the release liner is removed to expose the sticky butyl rubber material so that the patch can be adhered to the base sheet metal component in a desired location. The patches are typically small—less than 1 square foot in area—and easy to design and apply. The patches, however, can be relatively expensive and do not dampen vibrations as well as other techniques.

Laminated materials formed by sandwiching a thin polymer layer between two metal layers—a material called metal-plastic-metal (MPM)—have also been used to form entire sheet metal parts with the goal of the final part being capable of damping vibrations more than a typical sheet metal component. Damping approaches using MPM start with a roll or sheet of the MPM material that is stamped or formed into a desired shape. The resulting sheet metal component includes both layers of metal and the plastic layer throughout the entire part, increasing material costs as compared to a local patch. Parts made from MPM materials are heavier as a consequence of the extra materials included throughout the part. Separating the thinner layers of metal also results in a sheet of material that is not as stiff as a single sheet having the thickness of both metal layers would be. For example, two separate 0.020″ thick layers are more flexible than a single 0.040″ thick layer of sheet metal. Additionally, forming the whole part from the same MPM material results in similar vibration damping characteristics throughout the whole part.

A constraining or damping layer can also be stamped separately from and attached to the base layer via spot welding. A viscoelastic polymer material can be sandwiched between the base and damping layers to form a damping portion of the sheet metal component. The constrained and base layer are typically similar in thickness though the constrained layer might cover one third to one half of the base layer a viscoelastic polymer layer can be sandwiched between the constrained and base layers. Stamping the base and constrained layers separately increases costs and process time to produce the final part relative to forming an entire component from a sheet or roll of MPM material.

### SUMMARY

An exemplary damped sheet metal motor vehicle component formed from a single stamping operation includes a base layer, a viscoelastic polymer layer, and a constraining layer. The base layer is a sheet metal motor vehicle component. The viscoelastic polymer layer is in an expanded condition. The constraining layer is welded to the base layer through the viscoelastic polymer layer prior to the single stamping operation.

An exemplary sheet metal blank for a damped sheet metal motor vehicle component has a base layer, a viscoelastic polymer layer, and a damping layer. The base layer is a sheet metal motor vehicle component. The viscoelastic polymer is in an unexpanded condition. The constraining layer is welded to the base layer through the viscoelastic polymer layer thereby forming a plurality of gaps between the constraining layer and the unexpanded viscoelastic polymer layer.

An exemplary method of manufacturing a damped sheet metal component for a motor vehicle includes the steps of providing a sheet metal blank, shaping the sheet metal blank into a sheet metal component via a single stamping operation, and heating the sheet metal component to form the damped sheet metal component. The sheet metal blank includes a base layer, a constraining layer, and a viscoelastic polymer layer. The viscoelastic polymer layer is in an unexpanded condition in the sheet metal blank and the constraining layer is welded to the base layer through the viscoelastic polymer layer to form a plurality of gaps between the constraining layer and the viscoelastic polymer layer. Heating the sheet metal component causes viscoelastic polymer layer to expand to fill the plurality of gaps and to form the damped sheet metal component.

An exemplary damped sheet metal motor vehicle component formed from a single stamping operation includes a base layer, a viscoelastic polymer layer, and a constraining layer. The base layer is a sheet metal motor vehicle component and has a thickness of about 0.010 inches to about 0.050 inches. The viscoelastic polymer layer is in an expanded condition and has a thickness of about 0.010 inches to about 0.080 inches in an unexpanded condition. The constraining layer is welded to the base layer through the viscoelastic polymer layer prior to the single stamping operation. The constraining layer covers less than 100 percent of the base layer and has a thickness of about 0.010 inches.

An exemplary sheet metal blank for a damped sheet metal motor vehicle component has a base layer, a viscoelastic polymer layer, and a damping layer. The base layer is a sheet metal motor vehicle component and has a thickness of about 0.010 inches to about 0.050 inches. The viscoelastic polymer is in an unexpanded condition and has a thickness of about 0.010 inches to about 0.080 inches in an unexpanded condition. The constraining layer is welded to the base layer through the viscoelastic polymer layer thereby forming a plurality of gaps between the constraining layer and the unexpanded viscoelastic polymer layer. The constraining layer covers less than 100 percent of the base layer and has a thickness of about 0.010 inches to about 0.050 inches.

To further clarify various aspects of embodiments of the present disclosure, a more particular description of the certain embodiments will be made by reference to various aspects of the appended drawings. It is appreciated that these drawings depict only typical embodiments of the present disclosure and are therefore not to be considered limiting of the scope of the disclosure. Moreover, while the figures can be drawn to scale for some embodiments, the figures are not necessarily drawn to scale for all embodiments.

### BRIEF DESCRIPTION OF THE DRAWINGS

These and other features and advantages of the present invention will become better understood with regard to the following description and accompanying drawings in which:

FIG. 1 is a cross-sectional view of a composite sheet metal material having a viscoelastic polymer layer and a damping layer prior to thermal expansion of the viscoelastic polymer layer;

FIG. 2 is a cross-sectional view of the composite sheet metal material of FIG. 1 after thermal expansion of the viscoelastic polymer layer;

FIG. 3 is a top plan view of a blank formed from the composite material of FIG. 1 prior to stamping of the sheet metal component;

FIG. 4 is a perspective view of a sheet metal component formed by stamping the blank of FIG. 3 and thermally expanding the viscoelastic polymer layer;

FIG. 5 is an exploded view thereof;

FIG. 6 is a schematic diagram of a testing setup for measuring deflection of composite sheet metal materials;

FIG. 7 is a schematic view of the deflection of a first test sample formed from an MPM material;

FIG. 8 is a schematic view of the deflection of a second test sample formed from a constrained damping layer without embossing;

FIG. 9 is a schematic view of the deflection of a third test sample formed from a constrained damping layer that has been embossed;

FIG. 10 is a chart showing a plot of the normalized loss factor of different composite materials at different vibration frequencies;

FIG. 11 is a chart showing a plot of the normalized loss factor of different composite materials at 100 Hz and across a temperature range;

FIG. 12 is a chart showing a plot of the normalized loss factor of different composite materials at 200 Hz and across a temperature range; and

FIG. 13 is a flow diagram showing an exemplary method of manufacturing the sheet metal components described herein.

### DETAILED DESCRIPTION

The following description refers to the accompanying drawings, which illustrate specific embodiments of the present disclosure. Other embodiments having different structures and operation do not depart from the scope of the present disclosure.

As described herein, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members, or elements. Also as described herein, the terms “substantially” and “about” are defined as at least close to (and includes) a given value or state (preferably within 10% of, more preferably within 1% of, and most preferably within 0.1% of). Additionally, as used herein, the term “exemplary” is intended to mean serving as an illustration or example of something and is not intended to indicate a preference. As also described herein, a motor vehicle can be any vehicle that can be driven across the land and includes vehicles having all kinds of power sources, e.g., internal combustion engines running on gasoline or diesel fuel, electric motors powered by electricity from a fuel cell, electric motors powered by electricity stored in a battery, or the like. Motor vehicles include all sizes and classes of vehicles, such as, for example, motorcycles, cars, trucks, semi-trucks, and the like.

Sheet metal components including a constraining layer to reduce vibration can be 50% to 75% lighter than similar parts formed from MPM and can be thicker to improve the stiffness of the final part. A downside of the previous constraining layer approach, however, is the increased cost to manufacture the final part because two stamping operations are required for each part; that is, the base layer and the constraining layer are stamped separately and then assembled together. The composite materials and processes described herein facilitate the formation of a sheet metal component including a constraining layer that can be formed into a final shape in a single stamping operation. As described herein, a single stamping operation means moving a sheet metal blank onto a stamping press and removing the stamped part in its final shape without reintroducing the stamped part to the stamping press. During the stamping operation the stamping press may impact the sheet metal blank multiple times in different stations to form and trim the stamped part. That is, multiple hits of a stamping die at the same or different stations within a stamping press are considered part of the single stamping operation described herein.

Damping sheet metal components described herein are formed from a blank that includes a constraining or damping layer attached to a base layer via spot welding, rivets, stapling, adhesives, or the like. An expandable viscoelastic polymer layer is arranged between the constraining or damping layer and the base layer in an unexpanded condition. The constraining or damping layer is embossed with a pattern of ridges or dimples or other shapes to increase the stiffness of the constraining layer. The somewhat two-dimensional, flat blank is then stamped in a single stamping operation into a desired, three-dimensional shape. The stamping operation can be the same stamping operation as that used for parts made from an MPM material. After stamping the sheet metal blank into a sheet metal component, the viscoelastic polymer layer remains in an unexpanded condition and small gaps can be present between the unexpanded viscoelastic polymer layer and the constraining layer where the embossing of the constraining layer forms ridges in the constraining layer material. The viscoelastic polymer layer can also include openings to facilitate the attachment of the constraining layer to the base layer and to provide room for expansion of the viscoelastic polymer layer so that the viscoelastic polymer does not squeeze out from under the constraining layer during expansion.

The stamped part is then heated, causing the viscoelastic polymer layer to expand to fill any gaps between the base layer and the constraining layer and to further enhance the rigidity and vibrational damping features of the stamped part. The heating of the stamped part can be done as part of the regular downstream processes of a vehicle on an assembly line, such as, for example, passing the vehicle body through an oven to cure paint. Thus, the damping sheet metal components described herein weigh less, cost less, and perform better than sheet metal components employing known vibration damping techniques.

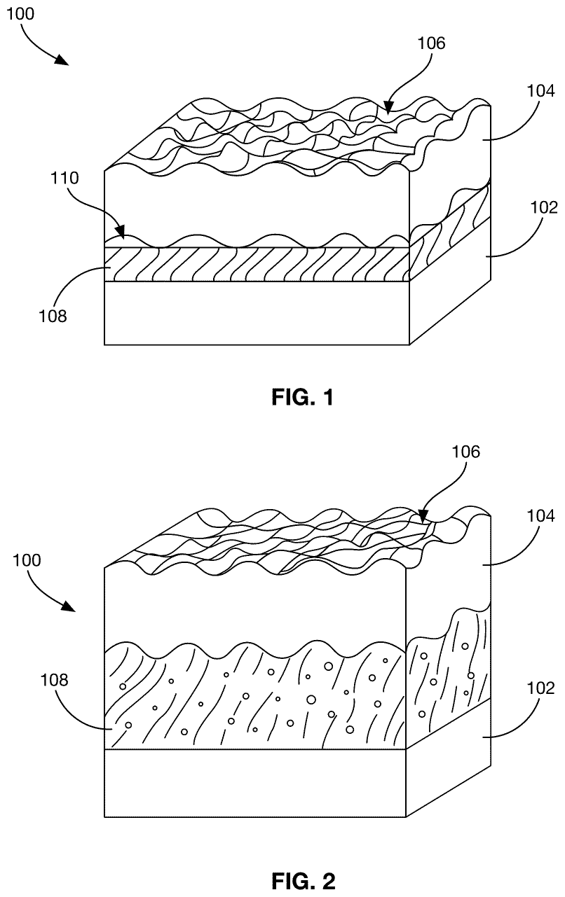

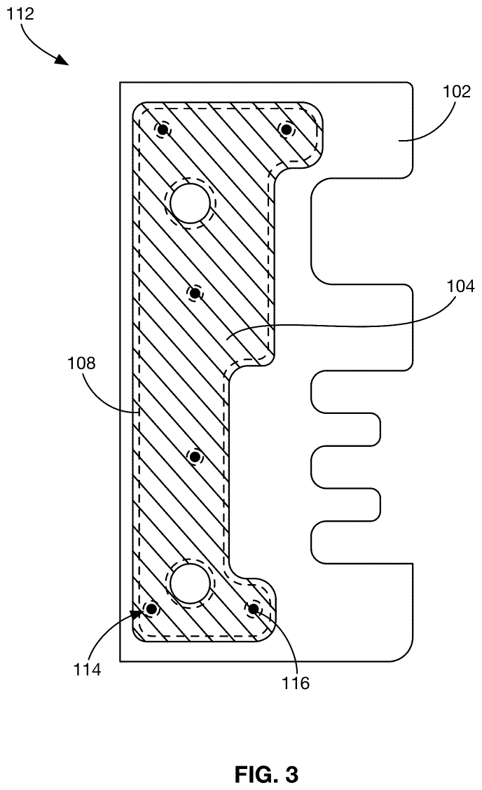

Referring now to FIGS. 1 and 2, cross-sectional views of a composite material 100 that dampens vibrations when used in a sheet metal component are shown. The composite material 100 includes a base layer 102 and a constraining or damping layer 104 that includes embossed features 106 such as ridges, dimpling, or the like. An expandable viscoelastic polymer layer 108 is formed between the base layer 102 and the constraining layer 104. The constraining layer 104 is attached to the base layer 102 via spot welding, rivets, stapling, adhesives, or the like as is shown in FIG. 3.

The viscoelastic polymer layer 108 can be expanded by the application of heat from an unexpanded condition (FIG. 1) to an expanded condition (FIG. 2). In the unexpanded condition, small gaps remain between the viscoelastic polymer layer 108 and the embossed features 106 of the constraining layer 104. These gaps 110 are filled by the viscoelastic polymer layer 108 in the expanded condition shown in FIG. 2. Providing gaps 110 by way of the embossed features 106 of the constraining layer 104 prohibits the viscoelastic polymer layer 108 from squeezing out from between the base layer 102 and the constraining layer 104 during expansion. The viscoelastic polymer is typically extruded at 1.25 mm thick prior to expansion, though the thickness of the viscoelastic polymer layer prior to expansion can be tailored to a desired thickness based on the size of the sheet metal blank and the desired stiffness of the damped sheet metal component.

The viscoelastic polymer layer is formed from a viscoelastic material that is thermally expandable, examples of which are discussed in further detail in U.S. Pat. Nos. 6,110,985 and 7,799,840. Viscoelastic materials exhibit both viscous and elastic characteristics; i.e., these materials resist shear flow and stretch and return to an original state after stress is applied and removed. The viscoelastic polymer can include combination of one or more of thermoplastic resin, plasticizer, inorganic filler, tackifier, process aid, blowing agent, and optionally one or more activator and/or colorant. When exposed to temperatures in a range of about 350 degrees Fahrenheit to about 425 degrees Fahrenheit for times ranging from about 45 minutes to about 15 minutes, the viscoelastic polymer expands through a foaming process to between about 30 percent to about 250 percent of the volume of the unexpanded viscoelastic polymer layer.

Referring now to FIG. 3, the composite material 100 is shown formed into a sheet metal blank 112 having a somewhat flat and two-dimensional geometry that can be shaped into a final sheet metal part in a molding or stamping operation. The base layer 102 of the composite material 100 is larger than and extends beyond the constraining layer 104 to the full size of the part. The viscoelastic polymer layer 108 is arranged between the constraining layer 104 and the base layer 102 and has a boundary inside the boundary of the constraining layer 104 to avoid squeezing out of the polymer material during stamping. One or more openings 114 are provided in the viscoelastic polymer layer 108 to provide space for the viscoelastic polymer layer 108 to expand during heating and for one or more attachment locations 116 where the constraining layer 104 is attached to the base layer 102 via an attachment means, such as, for example, spot welding, rivets, stapling, adhesives, or the like. In some implementations, the attachment locations 116 are positioned in areas of the sheet metal blank 112 that will not be deformed via the stamping operation.

The damping or constrained layer 104 is designed so that it covers an area of the damped sheet metal component 118 where structural stiffness is most important and where the vibration tends to be the greatest. The damped layer 104 does not cover the entire base layer 102 and typically covers only one-third to one-half of the base layer 102. The constraining layer 104 can be embossed as shown in FIGS. 1 and 2 and can optionally include a slight camber. Embossing of the constraining layer 104 increases the stiffness of a thinner sheet of metal to be similar to that of a thicker sheet of metal formed from the same material. The increased stiffness is an effect of strain hardening of the constraining layer 104 where localized plastic deformation of the sheet metal induced by the embossing process results in residual stresses and thus locally influences mechanical properties such as stiffness and yield strength.

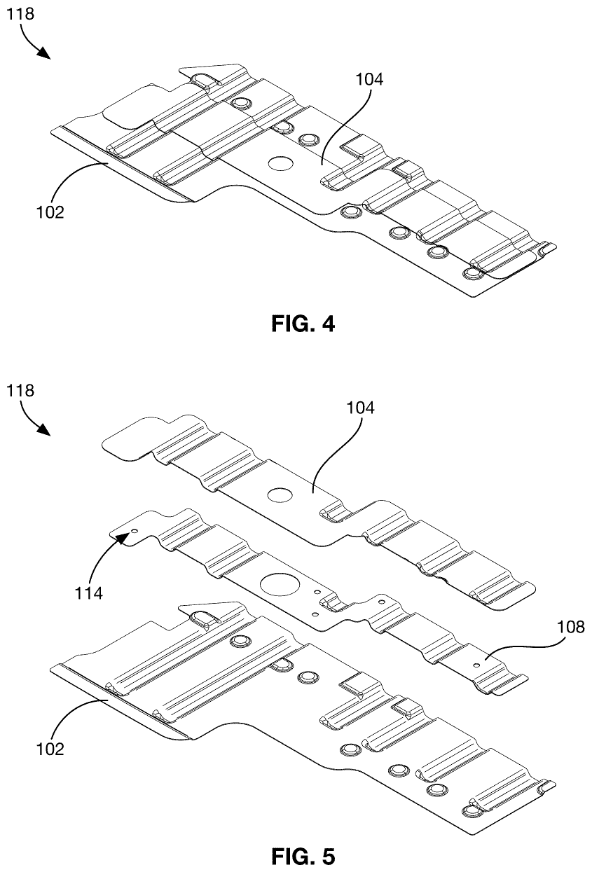

Referring now to FIGS. 4 and 5, a damped sheet metal component 118 is shown that is formed from a sheet metal blank 112 via a single stamping operation. Importantly, the single stamping operation is performed on the sheet metal blank 112 that includes all three layers of the damped sheet metal material 100, that is, the base layer 102, the constraining layer 104, and the viscoelastic polymer layer 108. Stamping all three layers 102, 104, 108 together reduces manufacturing time and cost while the structure and materials of the layers 102, 104, 108 provides improved damping performance of the damped sheet metal part 118, as will be shown in greater detail below. The embossing of the constraining layer 104 and the openings 114 in the viscoelastic polymer layer 108 provide clearance for the viscoelastic polymer to expand during heating without squeezing out onto the base layer 102. Small perforations can also be provided in the viscoelastic polymer layer 108 to provide further clearance as needed.

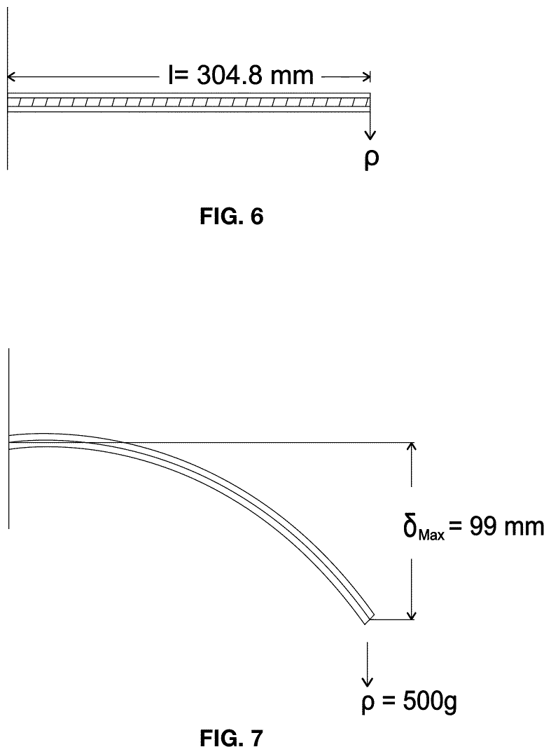

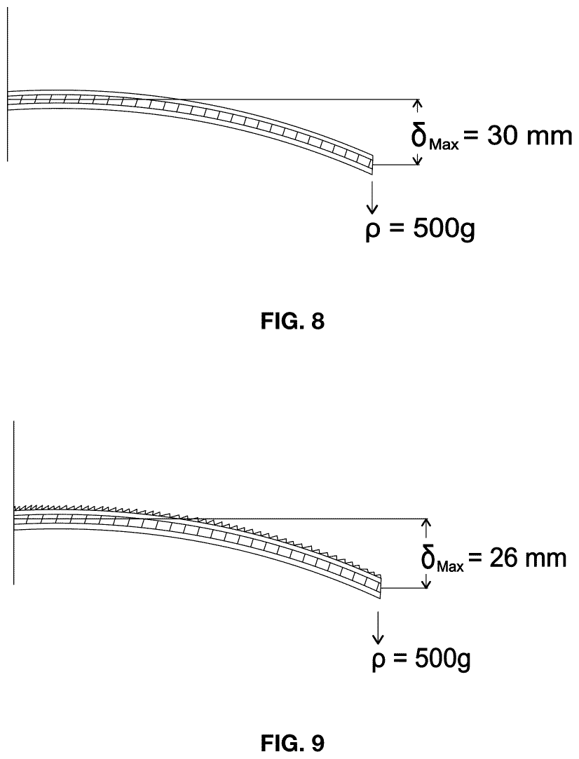

Referring now to FIGS. 6 to 9, samples of various composite materials were formed into elongated beam shapes and subjected to an external load at one end of the beam. The data listed in the chart below provides cantilever beam free-end deflection data for specified load applied to the free end. All specimens were of equal width (3 inches) and length (15 inches). During testing, all beams were fixed between two steel plates with the first 3 inches of the beam being fixed and 12 inches of the beam left free. One test specimen was formed from an MPM material, and the remaining specimen were formed according to the processes described herein. The MPM test sample consisted of two 0.020″ cold rolled steel layers with the thin plastic viscoelastic layer sandwiched between them. The damped sheet metal test specimens were formed according to the present disclosure and were differentiated by the thicknesses of the base and constrained layers as well as the percent coverage of the viscoelastic and constrained or damping layer. The base layer of each test samples was formed from TI-25 aluminized steel and the constrained or damping layers were formed from 304 stainless steel. A 0.060-inch-thick viscoelastic polymer was arranged between each. Four of five constrained layer specimens are not embossed. The embossed specimen is embossed with a 0.045″ emboss depth.

| | | 100 g | 200 g | 500 g |
|---|---|---|---|---|
| Material Construction | % Coverage of | Deflec- | Deflec- | Deflec- |
| Base Layer/Constrained | Constrained | tion | tion | tion |
| Layer | Layer | (mm) | (mm) | (mm) |
| .024″ ALZ/.015″ 304SS - | 50% | 4 | 9 | 26 |
| Embossed | | | | |
| .024″ ALZ/.020″ 304SS | 50% | 4 | 10 | 30 |
| .020″ ALZ/.020″ 304SS | 33% | 6 | 14 | 36 |
| .020″ ALZ/.020″ 304SS | 25% | 7 | 15 | 42 |
| .024″ ALZ/.015″ 304SS | 50% | 7 | 14 | 47 |
| .020″/.020″ cold rolled | 100% | 18 | 37 | 99 |
| steel MPM | | | | |

The results from the cantilever beam deflection test demonstrate the effectiveness of the exemplary composite structure's stiffness properties described herein. The exemplary damped sheet metal composite sample with only 25% coverage experienced less than half the deflection experienced by the MPM test sample. The data illustrates that the embossed material resists deflection the most out of all samples tested. That is, the damped sheet metal composite formed with an embossed constraining layer outperforms composites with thicker constraining layers.

Oberst testing with a loss factor normalized at 200 Hz was performed on exemplary damped sheet metal test samples and on MPM and butyl rubber test samples. Both Examples 1 and 2 of the damped sheet metal construction described herein had a base layer of 0.030-inch cold roll steel, a constraining metal layer with 0.020 inch embossed cold rolled steel, and the expanded polymer layer with a thickness of 0.060 inches and 0.080 inches, respectively. The MPM test sample has the construction of two layers of 0.015-inch-thick cold rolled steel, with a single layer of non-expandible polymer. The butyl rubber sample was 0.060 inch thick and sandwiched between 0.005-inch Aluminum foil and 0.030 inch cold roll steel. Tests were performed at 23 degrees Celsius and 40 degrees Celsius, as is shown in the table below.

| Loss Factor (200 Hz) | 23° C. | 40° C. |
|---|---|---|
| Example 1 - 0.060″ | 0.15 | 0.29 |
| viscoelastic layer | | |
| Example 2 - 0.080″ | 0.20 | 0.34 |
| viscoelastic layer | | |
| MPM (Prior Art) | 0.095 | 0.075 |
| Butyl Rubber (Prior Art) | 0.12 | 0.21 |

The exemplary damped sheet metal composites outperformed the prior art samples with as little as 50% coverage. (That is, only 50% of the base layer was covered with expandible polymer and embossed damping or constrained layer). Damping and stiffness of the exemplary damped sheet metal composite with a 0.015″ thick embossed constrained layer is much lighter than the MPM sample.

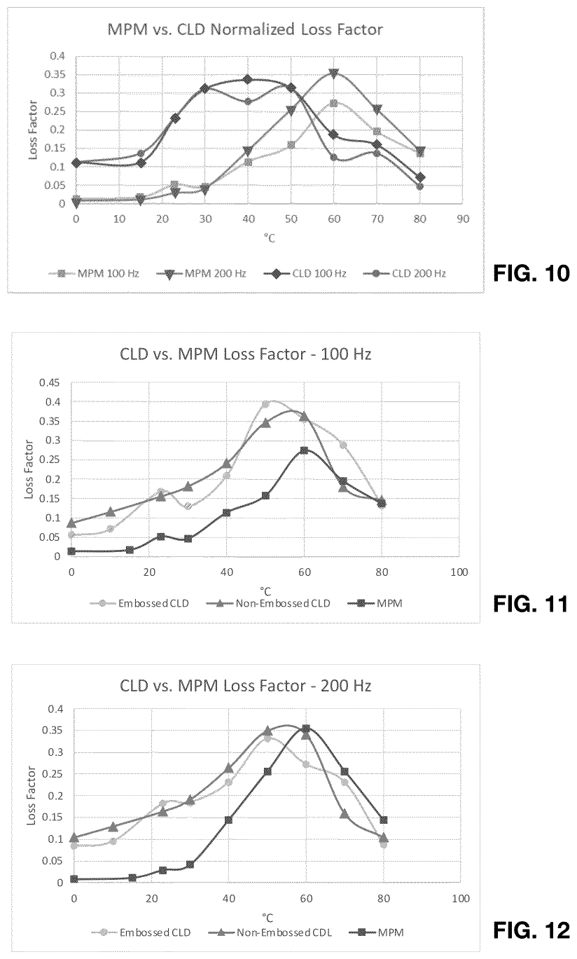

Referring now to FIGS. 10 to 12, charts are shown that further illustrate the effectiveness of exemplary damped sheet metal components described herein. Further investigation though Oberst testing of multiple samples of MPM and exemplary composite constrained layer damper (CLD) materials support the conclusions of the testing above. Oberst testing was conducted in environmental chambers within the temperature range of 0 degrees Celsius to 80 degrees Celsius. Loss factors were calculated via the half-power bandwidth method, detailed in ASTM E756, using the frequency response recorded by the Fast Fourier Transform Analyzer as specimens were subjected to randomized frequencies between 0 and 800 Hz. The resultant modes of resonance of each of the samples at specified temperatures were recorded and normalized to 100 and 200 Hz using linear extrapolation on a logarithmic scale. This normalization of frequency states the effective loss factor exhibited by the sample as if the sample was subject to 100 or 200 Hz.

Referring now to FIG. 10, the loss factor results over a wide range of temperatures are shown to illustrate the effective damping of relatively low to relatively high frequencies, 100 and 200 Hz, respectively. The CLD construction tested to provide the data for the chart of FIG. 10 includes a 0.031 inch cold rolled steel base layer, 0.060 inch expanded viscoelastic layer, and a 0.031 inch 304 stainless steel non-embossed constrained layer. The MPM construction was two layers of 0.020 inch laminated cold rolled steel with a non-expandable viscoelastic polymer. For the purposes of this application, the highly damped region of the graph pertains to a loss factor greater than 0.2. Very little to no damping occurs at values below 0.08. As can be seen in FIG. 10, the MPM exhibits peak damping for both 100 Hz and 200 Hz at an operating temperature of 60° C. The MPM loss factor shows more effective damping at higher frequencies, which are typically easier to dampen due to their shorter wavelengths and lower degree of resonance produced in automotive applications. The MPM loss factor also experiences a relatively narrow peak in the highly damped region of the graph. The exemplary CLD composite material exhibits highly damped properties in a wider temperature range and experiences much greater damping than MPM at operating temperatures below 50 degrees Celsius. As previously discussed, damping of lower frequency acoustics is more difficult to achieve and the exemplary CLD material is capable of effectively damping these lower frequencies over a wide temperature range.

Referring now to FIGS. 11 and 12, charts showing the results of additional testing on lighter gage base and constrained layers as well as embossed material is shown. In addition to the previously examined 0.040″ MPM construction, two CLD composite samples of 0.020″ cold rolled steel base layer, 0.060″ viscoelastic polymer, and 0.015″ 304 stainless steel constrained layer were Oberst tested. The difference between the two CLD samples was a 0.045″ depth emboss pattern on the constraining layer of one of the samples. The resulting loss factors for both embossed and non-embossed CLD samples are highly favorable compared to MPM at lower frequencies. In addition, the thinner steel composites see a right-ward shift in the loss factor data, typically seen in samples with enhanced stiffness. Applicant believes that these data show that the damping and stiffness of the CLD samples are largely the result of the viscoelastic polymer layer. The second round of Oberst testing, shown in FIGS. 11 and 12, clearly shows a propensity for the data from the MPM sample to dip below the “little to no damping” region of the graph below 30° C. whereas the data from the CLD samples barely, or not at all, trails into the region below temperatures of 10° C. at low frequencies. Applicant notes that the composition of the viscoelastic polymer material can be adjusted to alter the vibration damping performance of the damped sheet metal motor vehicle component. For example, Applicant has found that adding more plasticizer to the composition improves damping at lower temperatures and adding more filler improves damping at higher temperatures.

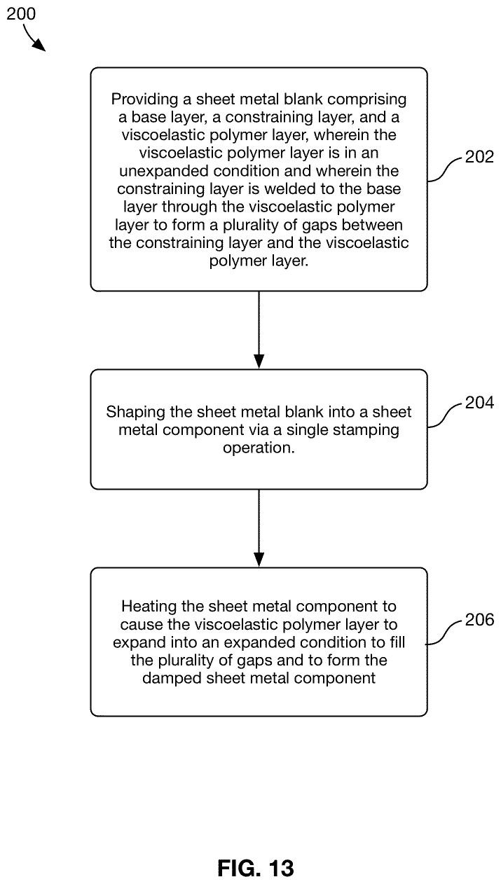

Referring now to FIG. 13, an exemplary method of manufacturing a damped sheet metal component is shown. A sheet metal blank is provided in step 202 that includes a base layer, an unexpanded viscoelastic polymer layer, and a constraining layer. The base layer can be provided in sheets of material or from a roll of sheet metal. The constraining layer can be attached to the base layer as described above and can be attached to a roll of base layer material traveling along a production line. The sheet metal blank is then stamped in step 204 in a single stamping operation to form a sheet metal component having the desired shape. In step 206, the assembled sheet metal component is heated to cause the viscoelastic polymer layer to expand into an expanded condition to fill gaps between the constraining layer and the viscoelastic layer to form the damped sheet metal component. Prior to heating the sheet metal component, the sheet metal component can be assembled to a partially assembled motor vehicle. The step of heating can be performed as the assembled motor vehicle passes through a paint curing oven.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, alternatives as to form, fit, and function, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein.

Additionally, even though some features, concepts, or aspects of the disclosures may be described herein as being a preferred arrangement or method, such description is not intended to suggest that such feature is required or necessary unless expressly so stated. Still further, exemplary, or representative values and ranges may be included to assist in understanding the present application, however, such values and ranges are not to be construed in a limiting sense and are intended to be critical values or ranges only if so expressly stated.

Moreover, while various aspects, features and concepts may be expressly identified herein as being inventive or forming part of a disclosure, such identification is not intended to be exclusive, but rather there may be inventive aspects, concepts, and features that are fully described herein without being expressly identified as such or as part of a specific disclosure, the disclosures instead being set forth in the appended claims. Descriptions of exemplary methods or processes are not limited to inclusion of all steps as being required in all cases, nor is the order that the steps are presented to be construed as required or necessary unless expressly so stated. The words used in the claims have their full ordinary meanings and are not limited in any way by the description of the embodiments in the specification.

1-15. (canceled)

16. A method of manufacturing a damped sheet metal component for a motor vehicle, the method comprising:
providing a sheet metal blank comprising a base layer, a constraining layer, and a viscoelastic polymer layer, wherein the viscoelastic polymer layer is in an unexpanded condition and wherein the constraining layer is welded to the base layer through the viscoelastic polymer layer to form a plurality of gaps between the constraining layer and the viscoelastic polymer layer;
shaping the sheet metal blank into a sheet metal component via a single stamping operation; and
heating the sheet metal component to cause the viscoelastic polymer layer to expand into an expanded condition to fill the plurality of gaps and to form the damped sheet metal component.

17. The method of claim 16, wherein the constraining layer comprises embossed features that form the plurality of gaps between the constraining layer and the viscoelastic layer.

18. The method of claim 16, further comprising assembling the sheet metal component to a partially assembled motor vehicle body prior to heating the sheet metal component.

19. The method of claim 16, wherein the viscoelastic polymer layer volumetrically expands from between thirty percent to about two-hundred-fifty percent during heating and expansion of the viscoelastic polymer layer is unconstrained by the constraining layer.

20. The method of claim 16, wherein the viscoelastic polymer layer has a thickness of about 0.010 inches to about 0.080 inches in the unexpanded condition.

21-22. (canceled)

23. A method of manufacturing a sheet metal blank for a damped sheet metal motor vehicle component, the method comprising:
providing a sheet metal blank comprising a base layer, wherein the base layer is a sheet metal motor vehicle component;
applying a viscoelastic polymer layer to the base layer of the sheet metal blank, wherein the viscoelastic polymer layer is in an unexpanded condition; and
welding a constraining layer to the base layer, wherein the constraining layer is welded to the base layer through the viscoelastic polymer layer to form a plurality of gaps between the constraining layer and the viscoelastic polymer layer.

24. The method of claim 23, further comprising shaping the sheet metal blank into a sheet metal component via a single stamping operation.

25. The method of claim 24, further comprising heating the sheet metal component to cause the viscoelastic polymer layer to expand into an expanded condition to fill the plurality of gaps and to form the damped sheet metal component.

26. The method of claim 25, further comprising assembling the sheet metal component to a partially assembled motor vehicle body prior to heating the sheet metal component.

27. The method of claim 25, wherein the viscoelastic polymer layer volumetrically expands from between thirty percent to about two-hundred-fifty percent during heating.

28. The method of claim 23, further comprising forming embossed features in the constraining layer prior to welding the constraining layer to the base layer.

29. The method of claim 23, wherein applying the viscoelastic polymer layer forms a plurality of perforations in the viscoelastic polymer layer.

30. The method of claim 23, further comprising forming a plurality of perforations in the viscoelastic polymer layer.

31. The method of claim 23, wherein the viscoelastic polymer layer is applied to less than 100 percent of the base layer.

32. The method of claim 31, wherein the constraining layer completely covers the viscoelastic polymer layer.

33. The method of claim 31, wherein a first area of the viscoelastic polymer layer is less than a second area of the constraining layer.

34. The method of claim 23, wherein the viscoelastic polymer layer has a thickness of about 0.010 inches to about 0.080 inches in the unexpanded condition.

35. The method of claim 23, wherein the base layer and the constraining layer each have a thickness of about 0.010 inches and 0.050 inches.

36. The method of claim 23, wherein the base layer and the constraining layer each have the same thickness.

37. The method of claim 23, wherein the constraining layer has a surface area that is less than a surface area of the base layer.

38. The method of claim 23, wherein the base layer is a sheet metal motor vehicle component.

39. A method of manufacturing a sheet metal motor vehicle component, the method comprising:
providing a sheet metal blank comprising a base layer, wherein the base layer has a thickness of about 0.010 inches to about 0.050 inches;
applying a viscoelastic polymer layer to the base layer of the sheet metal blank, wherein the viscoelastic polymer layer is in an unexpanded condition, and wherein the viscoelastic polymer layer has a thickness of about 0.010 inches to about 0.080 inches in the unexpanded condition;
welding a constraining layer to the base layer through the viscoelastic polymer layer to form a plurality of gaps between the constraining layer and the viscoelastic polymer layer, wherein the constraining layer has a thickness of about 0.010 inches to about 0.050 inches;
shaping the sheet metal blank into a sheet metal component via a single stamping operation; and
heating the sheet metal component to cause the viscoelastic polymer layer to expand into an expanded condition to fill the plurality of gaps and to form the damped sheet metal component.
